(19) United States
(12) Patent Application Publication
(10) Pub. No.: US 2002/0023127 A1
(43) Pub. Date: Feb. 21, 2002

(54) Asynchronous hyperlink object

(76) Inventor: Roya Rezvani Sabeti, University Place, WA (US)

Correspondence Address: Roya Sabeti, 5610 - 80th AVE. CT. W., UNIVERSITY PLACE, WA, 98467, US

(21) Appl. No.: 09/911,225

(22) Filed: Jul. 24, 2001

Related U.S. Application Data
(60) Provisional application No. 60/225,414, filed on Aug. 15, 2000.

(51) Int. Cl. G06F 15/16

(52) U.S. Cl. 709/203; 709/227

(57) ABSTRACT

An asynchronous model for interacting with web servers is presented here. In this model, the web browser sends requests using currently used protocols such as HTTP. This asynchronous model applies when a) the client requests data that is not available immediately, and b) when the client and web server are interacting over an ongoing task. An example of the first case is when the server has to search massive amounts of data. An example of the second case is when the client is tracking the status of a shipment. We define asynchronous links or Asynchronous Hyperlink Objects (AHO) for this new model. In this asynchronous model the web server informs the client immediately that the client's request was received, agents are created for both the client and server. These agents keep track of the status of the request, inform the client of any changes in the status, and are active until the interaction is concluded. In the current and conventional situation, the interaction between the web browser and the web server is based on synchronous interactions and links. We call these link Synchronous Hyperlink Objects (SHO), because when a client sends a request to a web server, the client must wait for a response before any further steps can be taken. There is often no immediate feedback on whether the request will be fulfilled or not, or even whether the request was received at all. In this disclosure, the implementation of the asynchronous model and the application of this new model for web browser to web server interaction are presented.

### BACKGROUND

This invention relates to the communication between clients and servers on network environments through the Internet or through Intranets.

Network clients such as web browsers or media players communicate with web servers and other server side applications through different protocols such as Hypertext Transfer Protocol (HTTP) or RTSP. These protocols define a set of rules that are followed when clients connect with servers. Although we examine in detail certain aspects of the HTTP, the same concepts and observations apply to other protocols.

A web browser connects to the server using the domain name specified in the Uniform Resource Locator (URL). The URL specifies the communication protocol (e.g. HTTP), the server domain name, the resource location and any data parameters. An example is http://www.server.com/index.html. In this example, the communication protocol is “HTTP”, the server domain name is “www.server.com”, the resource location is “index.html”, and there are no additional parameters. Once the web browser connects to the web server, the request is processed in accordance to the rules in the HTTP protocol. The web browser then displays the content of the resource location. This is a “web page.” FIG. 1 depicts the communication of a web browser with the web server.

HTTP allows access to digital data (text, graphics, sound, video, etc.) using a language called Hypertext Markup Language (HTML). HTML is a standard that provides basic formatting of the web page and allows the inclusion of “hyperlinks” to other pages, other servers and other resources.

The Nature of Client to Server Communication

We introduce the term “synchronous hyperlink object” (SHO) to represent the current synchronous nature of the interaction between the client and the web server. It is synchronous because the client waits for a response from the web server after it sends a request. The interaction between the client and the server occurs synchronously. All requests made by the web browser are synchronous. Every time a user clicks on a hyperlink, a request is made to that web server and the web browser waits for a response from that web server.

The “web model” is a synchronous model. This system works well as long as the server can respond immediately. However due to high traffic and other factors, the capacity of the web server can become strained. At this point, the response time increases and the client may wait for a long period of time before the server responds. Users would quickly lose interest in a web site if the response time exceeded a few seconds.

The capacity of a server to respond is affected by many factors. For example, high network traffic exceeding the capacity of the Internet connection, too many requests at the same time, the size of the requested resource, or the fact that the requested resource requires computation and is not readily available.

One shortcoming of the synchronous model is the lack of feedback on data availability. The user gets no feedback on whether the requested resource is available. Instead, the server responds based on the availability of the resource in that particular session. The server either responds within a reasonable time, or with an error condition indicating that the resource is not available and the session is terminated. Even if the resource can be obtained at a later time (for example, it exists in back-up storage, or additional computation is required), the synchronous model has no provision to provide feedback to the client or to queue the request for later processing. This shortcoming results in a loss of service or lower quality service because the response time exceeds the user's expectations.

This invention proposes a new model for client-web server communication that addresses the lack of feedback and waiting associated with the synchronous model and enhances the communication by keeping the client informed of the status of the pending tasks until they are completed.

### BRIEF SUMMARY OF THE INVENTION

In this invention, we define the Asynchronous Hyperlink Object (AHO) and AHO Agent for accessing data from a web browser. The communication model in this invention allows asynchronous interaction between the client and the web server while utilizing the familiar HTTP protocol.

The asynchronous model takes effect in the following two scenarios:

a) The server cannot process the client request immediately.

b) The availability of the resource requested by the client involves a process that takes time, for example, the tracking of a package through a shipping company.

Workflow

Client requests are typically handled through the normal synchronous model. If the request cannot be serviced within a reasonable time limit, then the request is converted to an asynchronous link or AHO. This process is completely transparent to the client and requires no action on the part of the client. The process is automatically activated when the server cannot respond in a timely manner. First, the web server responds that the request has been received but that it cannot fulfill the request immediately. Second, AHO “Agents” are created for both the client and the server. These agents are responsible for keeping track of the pending request and automatically informing the client of its progress.

In the preferred embodiment of this invention, the client GUI (Graphical User Interface) presents a list of AHOs representing each pending or in-progress request. Each AHO will have an associated icon that shows the progress. Additional information can be obtained by clicking on this icon.

The process for each AHO ends with one of the following 3 outcomes:

a) The request is fulfilled and the information is delivered to the client.

b) The request is fulfilled, the information is available, but it is not delivered within a reasonable time. For example, the user has closed the web browser.

c) The request cannot be fulfilled.

In case a), the AHO goes from the active AHO list to the history list. In case b), the AHO agent goes to an “Orphan” list. If the client wants to view the information the request must be resubmitted. In the third case, the web server may respond with a suggestion for an alternative. This could be an opportunity for the user to accept the alternative or correct any errors in the request. For example, if the client requested a particular book from Amazon.com, Amazon may respond that the exact title requested is not available but there is another title that is very similar and may be the correct title. Or Amazon may suggest other titles by the same author, etc. It is then up to the client to terminate the request or accept the suggested modification, which creates a new AHO agent, and the process starts again.

In the preferred embodiment of this invention, there are several types of AHOs as described below:

Predictable AHO: The server can predict the length of time that will be required to fulfill the client's request and informs the client of this wait time.

Unpredictable AHO: The server cannot predict how long it will take to fulfill the client's request.

Time-based AHO: The server specifies a date and time of day when the data will be available.

Count-based AHO: The server sets a target number of requests. When it receives that number, it then makes the data available to all clients.

Priority-based AHO: The server uses a priority rating for providing the data. The priority can be high, medium or low. The server handles requests in order of decreasing priority. For example, this rating could be based on whether the client is paying a fee or not, i.e., the client is given an option to pay a fee to get a high priority rating.

### APPLICATIONS OF THE INVENTION

The asynchronous model applies to many aspects of the communication between clients and web servers. A few examples are listed and reference is made to the different types of AHOs in the context of some of these applications:

1. The asynchronous model applies to any web server that manages massive amounts of data or any servers that need a long time to fulfill a request from the client.

The data for these types of servers are backed up on media such as CD, tape or other types of slow access storage devices. Retrieving data from such media requires more time so the web server uses AHO and AHO agents to retrieve data and inform the client when it is available. The following items are a few examples where massive storage is required to maintain data, and the AHO and AHO agent technology can be used for accessing the data. In all of these examples, current technology can only accommodate a limited number of hyperlinks (SHOs). There is a finite amount of space available on the web server's hard drive, therefore a limited amount of data is immediately accessible; for example, today's interview with the President on CNN's website. Older data may reside on secondary media; for example, all interviews with former Presidents that were accessible on CNN's website at some point in time. With AHO technology, all of this data can have a hyperlink associated with them. When the data is on its hard drive, the web server responds with an SHO. If the data is on secondary media, selecting its hyperlink will result in an AHO.

Multimedia data

Multimedia data such as digital videos, audio files, or digital pictures require massive amounts of storage. These types of data typically do not fit on the server hard drives and are stored on CD or tapes. When a web browser sends a request for a web page that contains multimedia files, the web server may obtain the multimedia files from archived storage. In this case, the web server cannot respond to the web browser request in synchronous mode. The web server uses the AHO and AHO agent to inform the web browser that the data is available at a later time.

Library of Congress data

The Library of Congress requires massive amount of storage for maintaining large amounts of information. When users request to view data in the Library, the web server may require more time to obtain the archived data from storage. The web server uses the AHO and AHO agents to inform the web browser that the data is available at a later time.

Research data for different research organizations

Scientists always share their research data among the scientific communities. The research data may require massive storage in order to record the raw data of the scientific studies. If a scientist requests information on a particular study, then the web server may require time to obtain the data from a massive storage device. The web server uses the AHO and AHO agents to inform the web browser that the data is available at a later time.

Archive of all the digital data produced daily in the world

As time goes by, more and more data will be archived in digital form on media not conducive to immediate access. AHO and AHO agents will provide the needed link to access this data.

Some examples of different types of AHOs in this context include:

Predictable AHO: An interview regarding a historically significant event has been requested often enough that the web server can predict the time required to make it available.

Unpredictable AHO: An obscure article is requested from the Library of Congress, and it is not clear how long it will take to make it available to the client.

Time-based AHO: the movies, “It's a Wonderful Life” and “Miracle on 34^{th} Street” will be available for viewing during the Christmas season.

2. The asynchronous model applies when informing the client of the progress of a particular task. The following items are just a few examples in which the AHO and AHO agent technology can be used for accessing the data:

When a user tracks the shipment of a purchased item over the web, the user repeatedly attempts to view the shipment status of the item. This is the synchronous way of accessing the data and is controlled by the clients. In the asynchronous model, the user automatically receives all of the updated information on the shipment from the web server. There is an AHO agent on the display device of the client, which informs the user of any updates regarding the shipment. In this case, the user does not need to repeatedly request the data because the server automatically sends the data.

Another example relates to conducting a complex transaction online, for example, buying a house. This transaction would involve multiple people: realtor, seller, loan officer, etc. The transaction would be conducted in multiple stages some of which would depend on the successful completion of a previous stage. AHO technology is capable of organizing and initiating each necessary step. Once the process is started and an AHO is initiated, this AHO could generate other necessary AHOs, and keep the client informed of the next step and the progress of each ongoing task. AHOs generated by another AHO will be defined as derivative AHOs.

3. The asynchronous model can be used in E-commerce when the price of products is subject to change. For example, a client may request to be notified when a particular product is on sale. With an AHO agent, the client does not have to periodically check the e-tailer's web site or check e-mail, etc. Instead, the AHO icon will flash when the desired product is on sale. Another example is with airline tickets in which the client may set a target price and can be notified automatically if the tickets become available at that price.

4. The asynchronous model can be used whenever a web server is down for maintenance or any other reason. A standby server can come online that will acknowledge clients' requests and inform them that the request will be fulfilled at a later time. The standby server also generates AHO agents so that no client is lost.

### BRIEF SUMMARY OF FIGURES

FIG. 1 is a diagram showing the typical interaction between web servers and web browsers.

FIG. 2 shows the components involved in the interaction between clients and web server using the asynchronous model.

FIG. 3 is a flow chart describing the steps involved in getting data from a server using the asynchronous model.

FIG. 4 is a flow chart describing the steps involved when the interaction between client and web server concerns an ongoing process.

FIG. 5 is a simplified version of FIG. 2.

FIG. 6 is a flow chart describing the steps involved in the simplified asynchronous model.

FIG. 7 shows the components involved in the interaction between clients and web server when the web server is not available and a standby server is used to keep track of client requests.

FIG. 8 is a flow chart describing the steps involved in using a standby server.

FIG. 9 is a flow chart describing the steps involved in using an asynchronous server.

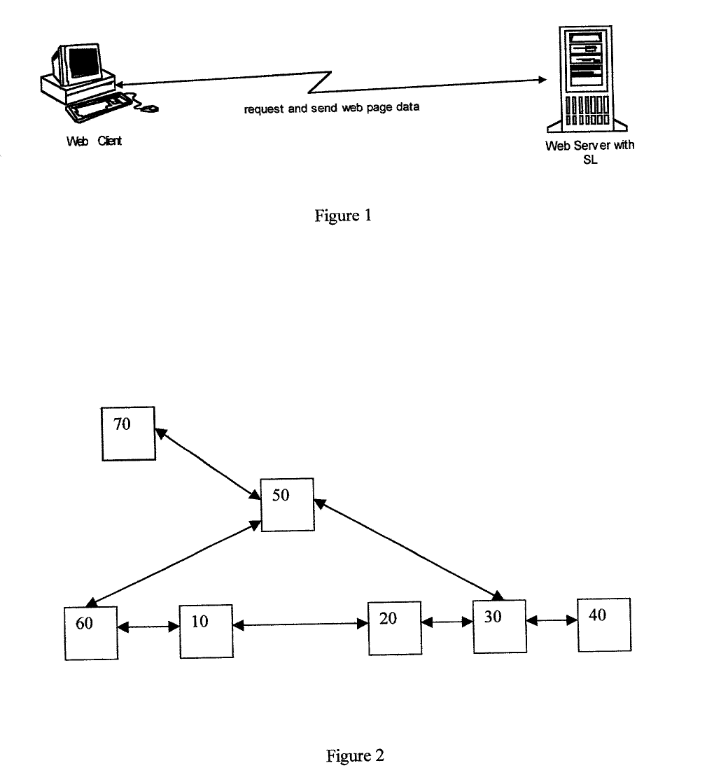

### DETAILED DESCRIPTION OF INVENTION

The following is a detailed description of the components and steps involved in using the asynchronous model to handle situations when a client request cannot be fulfilled immediately.

FIG. 2 shows the components involved in the interaction between clients and web server using the asynchronous model. Block 10 is the client, block 20 is the web server, block 30 is the Server AHO Agent, block 40 is the Server AHO Fulfillment server, block 50 is the Client AHO Fulfillment server, block 60 is the Client AHO Agent, and block 70 indicates other devices which may be used to notify clients of changes in the status of their request.

Blocks 10 and 20, the client and web server, can be either part of the Internet or machines on an Intranet.

The Server AHO Agent, block 30, is initiated by the web server and the Client AHO Agent, block 60, is initiated by the client. In the preferred embodiment of the invention, these two Agents are software programs that are active whenever the interaction between client and server is asynchronous. The Agents may be implemented using other methods including hardware devices.

Block 40, the Server AHO Fulfillment server, is a server on the network dedicated to processing all web requests made of the web server that cannot be fulfilled synchronously. Block 50, the Client AHO Fulfillment server, is a server on the network that knows the location of the client and server involved in any asynchronous interaction because the client and server both register with the Client AHO Fulfillment server. The two Agents communicate through this server.

Block 70 indicates all other methods, other than through the Client AHO Agent, which may be used to communicate with the client. For example, the Client AHO Fulfillment server may send email, may initiate a telephone call, contact a pager, etc.

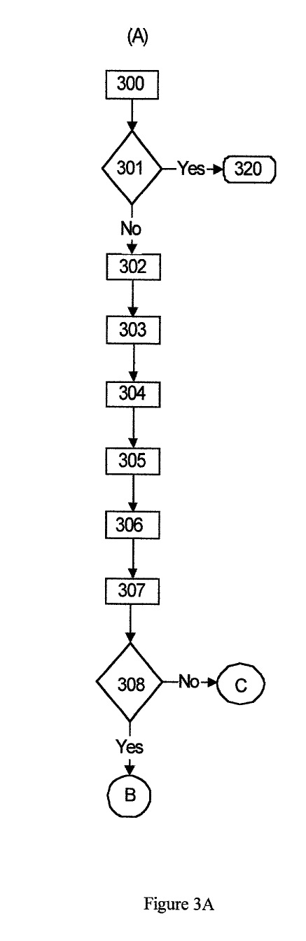

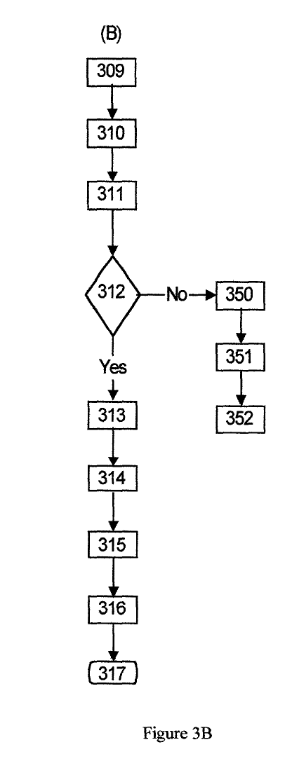

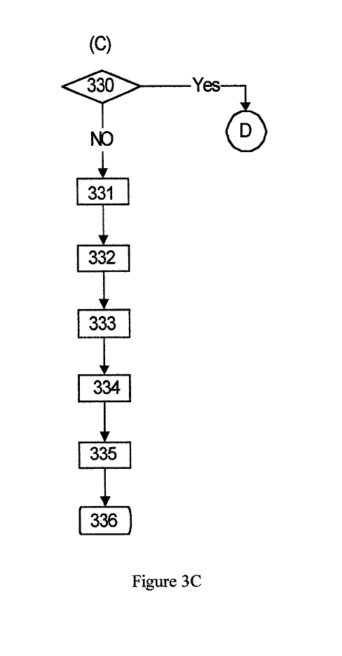

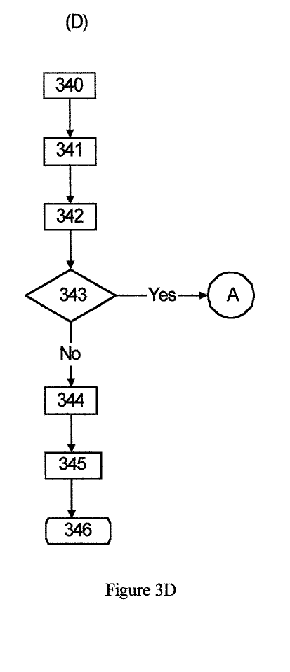

FIG. 3A is a flow chart describing the steps involved in getting data from a server using the asynchronous model. The process starts when the client requests data from the server, step 300. Step 301 indicates there are two possible responses to the request. Either the data requested is available in real time, or the data is not immediately available. If the data is available, the server fulfills the request in real time, step 320, and the process ends. If the data is not available immediately, the asynchronous interaction starts.

In Step 302, the web server initiates the Server AHO Agent, or SAHOA, program. This SAHOA is added to the SAHOA list. In step 303, the SAHOA registers with the Server AHO Fulfillment server, and in step 304, the SAHOA registers with the Client AHO Fulfillment server.

In step 305, the web server informs the client that the data requested is not immediately available, but that an AHO agent has been initiated and the client will be informed when the data does become available.

The client initiates the Client AHO Agent, or CAHOA, program in step 306. This CAHOA is added to the CAHOA list.

In step 307, the CAHOA registers with the Client AHO Fulfillment server. The presence of an active Client AHO Agent is shown by updating the appropriate icons on the client's display device.

Step 308 indicates there are two outcomes to the search for the data requested. Either the data is found, process B shown in FIG. 3B, or it is not found, process C shown in FIG. 3C.

Process B: If the data is found, the Server AHO Fulfillment server notifies the SAHOA that the data is available in step 309.

The SAHOA notifies the Client AHO fulfillment server that the data is available in step 310.

The Client AHO Fulfillment server notifies the CAHOA and/or other device(s) that the data is available in step 311. This change is indicated by the CAHOA in some way, possibly an icon on the client's display device flashing.

Step 312 indicates that there are two possible responses from the client. Either the client ignores the notification or the client views the data in a reasonable time.

If the client ignores the notification, the AHO goes to the Orphan AHO List as in step 350. Step 351 indicates that the SAHOA is destroyed, and step 352 indicates that the CAHOA is destroyed and the interaction ends. If the client wants to see the data, he must start from the beginning with a new data request.

If the client responds by requesting to view the data in step 313, the server provides the data in real time in step 314.

Step 315 indicates that the AHO then goes to the History list.

The Agent programs stop (SAHOA stops in step 316 and CAHOA stops in step 317) and the process ends.

Process C: If the data requested is not found, the web server may have an alternative to suggest. This may occur when the client requests a product that is no longer available but similar products are available. Step 330 indicates that either the web server has an alternative to suggest, process D shown in FIG. 3D, or it does not.

Process D: If the server has an alternative to suggest, then in step 340, the Server AHO Fulfillment server notifies the SAHOA that the data is not available but that it can provide an alternative.

In step 341, the SAHOA notifies the Client AHO Fulfillment server that the specific data requested is not available but that it can provide an alternative.

In step 342, the Client AHO Fulfillment server notifies the CAHOA and/or other device(s) that the data is not available but an alternative is available. This change is indicated by the CAHOA in some way, possibly an icon on the client's display device flashing.

Step 343 indicates that there are two outcomes in this case, either the client wants to pursue the suggested alternative or the client declines the offer.

If the client wants to pursue the suggested alternative, the process starts again at step 300 with the revised request.

If the client declines the offer, the AHO goes to the orphan list (step 344), the Agent programs stop (the SAHOA in step 345 and the CAHOA in step 346), and the process ends.

If the server does not have an alternative to suggest, then in step 331, the Server AHO Fulfillment server notifies the SAHOA that the data is not available.

In step 332, the SAHOA notifies the Client AHO Fulfillment server that the specific data requested is not available.

In step 333, the Client AHO Fulfillment server notifies the CAHOA and/or other device(s) that the data is not available. This change is indicated by the CAHOA in some way, possibly an icon on the client's display device flashing.

The AHO goes to the Orphan List (step 334), the Agent programs stop (step 335 for the SAHOA and step 336 for the CAHOA), and the process ends.

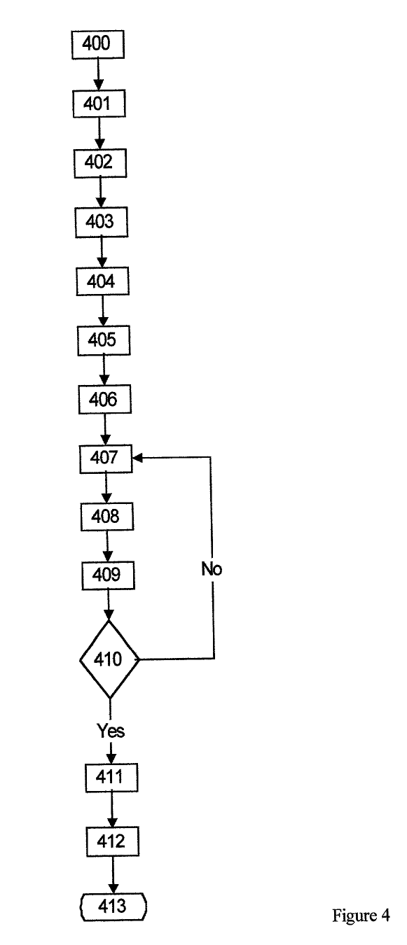

FIG. 4 is a flow chart describing the steps involved when the interaction between client and web server concerns an ongoing process, for example, tracking a shipment from source to destination.

Step 400 indicates when the process starts, e.g. the package is shipped from the source.

Step 401 describes when the web server initiates the Server AHO Agent, or SAHOA, program. This SAHOA is added to the SAHOA list. In step 402, the SAHOA registers with the Server AHO Fulfillment server, and in step 403, the SAHOA registers with the Client AHO Fulfillment server.

In step 404, the web server informs the client that an AHO agent has been initiated and the client will be informed of every updated change in the status of the shipment.

The client initiates the Client AHO Agent, or CAHOA, program in step 405. This CAHOA is added to the CAHOA list.

In step 406, the CAHOA registers with the Client AHO Fulfillment server. The presence of this active Client AHO Agent is shown by updating the appropriate icons on the client's display device.

In step 407, the Server AHO Fulfillment server notifies the SAHOA of a change in the status of the process; for example, the package is now on an airplane from one city to another.

The SAHOA notifies the Client AHO Fulfillment server of this change in step 408.

In step 409, the Client AHO Fulfillment server notifies the CAHOA and/or other device(s) of the change in status. This change is indicated by the CAHOA in some way, possibly an icon on the client's display device flashing.

Step 410 indicates there are two possibilities at this point, either the change in status is the end of the process, or it is an intermediate step.

If this is the last step in the process, e.g. the package is at its destination, step 411 indicates that the AHO goes to the History List.

The Agent programs stop (step 412 for the SAHOA and step 413 for the CAHOA) and the process ends.

If the change in status is an intermediate step, the flow chart loops back to step 407 and waits for another change to occur.

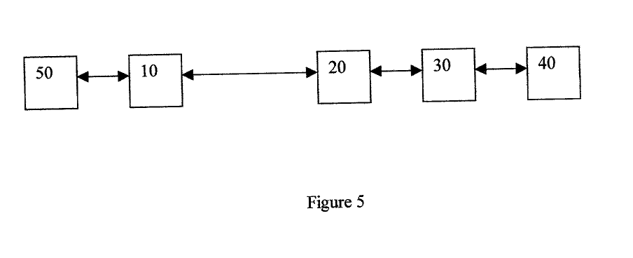

FIG. 5 shows the components required for a simplified version of the asynchronous model.

Blocks 10 and 20, the client and web server, can be either part of the Internet or machines on an Intranet.

The Server AHO Agent, block 30, is initiated by the web server and the Client AHO Agent, block 50, is initiated by the client as in the normal asynchronous model.

Block 40, the Server AHO Fulfillment server, is a server on the network dedicated to processing all web requests made of the web server that cannot be fulfilled synchronously.

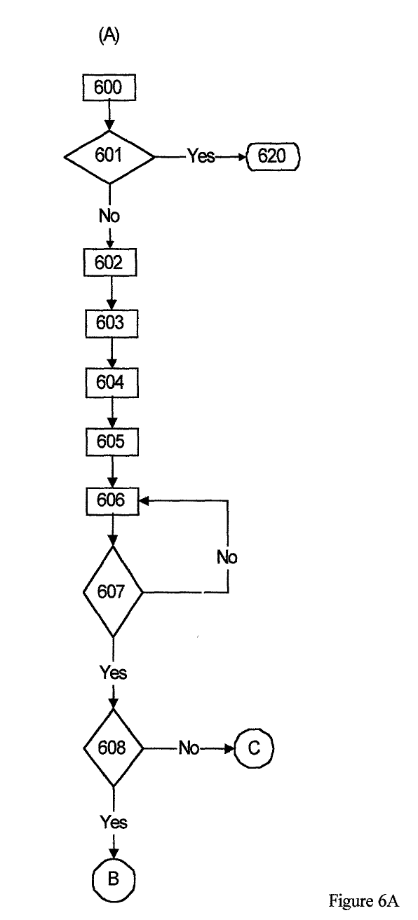

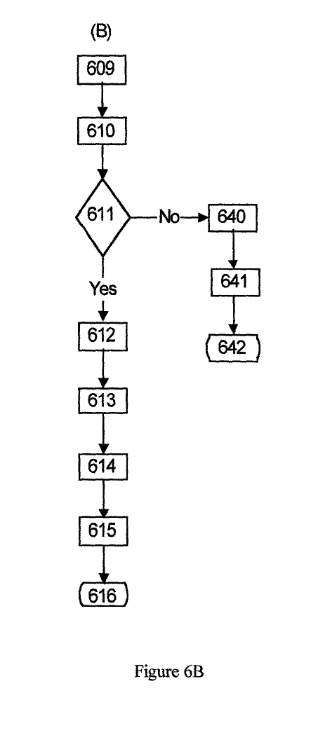

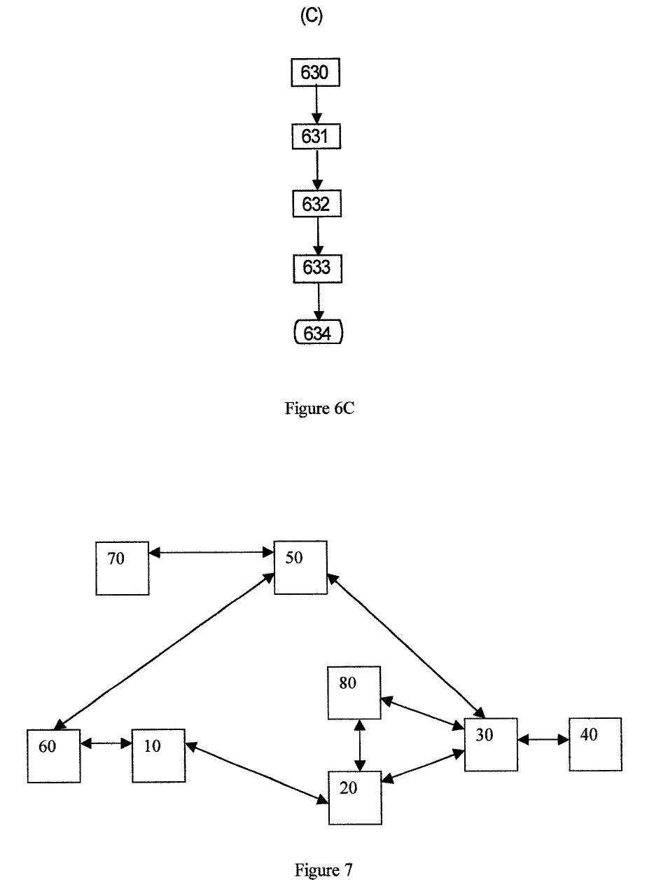

FIG. 6A is a flow chart describing the steps involved in the simplified asynchronous model. The process starts when the client requests data from the server, step 600. Step 601 indicates there are two possible responses to the request. Either the data requested is available in real time, or the data is not immediately available. If the data is available, the server fulfills the request in real time, step 620, and the process ends. If the data is not available immediately, the asynchronous interaction starts.

Step 602 indicates when the web server initiates the Server AHO Agent, or SAHOA, program. This SAHOA is added to the SAHOA list. In step 603, the SAHOA registers with the Server AHO Fulfillment server.

In step 604, the web server informs the client that the data requested is not immediately available, but that an AHO agent has been initiated and the client will be informed when the data does become available.

The client initiates the Client AHO Agent, or CAHOA, program in step 605. This CAHOA is added to the CAHOA list. The presence of this active Client AHO Agent is shown by updating the appropriate icons on the client's display device.

In step 606, the CAHOA requests an update from the web server.

Step 607 indicates that the Server AHO Fulfillment server's search may or may not have ended.

If the search is still continuing, the SAHOA has no response for the request and the process loops back to step 606.

Step 608 indicates there are two outcomes to the search for the data requested. Either the data is found, process B shown in FIG. 6B, or it is not found, process C shown in FIG. 6C.

Process B: If the data is found, the Server AHO Fulfillment server notifies the SAHOA that the data is available in step 609. The SAHOA notifies the CAHOA that the data is available in step 610. This change is indicated by the CAHOA in some way, possibly an icon on the client's display device flashing.

Step 611 indicates that there are two possible responses from the client. Either the client ignores the notification or the client views the data in a reasonable time.

If the client ignores the notification, the AHO goes to the Orphan AHO List as in step 640. The Agent programs stop (step 641 for the SAHOA and step 642 for the CAHOA) and the process ends. If the client wants to see the data, he must start from the beginning with a new data request.

If the client responds by requesting to view the data in step 612, the server provides the data in real time in step 613.

Step 614 indicates that the AHO then goes to the History list.

The Agent programs stop (step 615 for the SAHOA and step 616 for the CAHOA) and the process ends.

Process C: If the data is not found, the Server AHO Fulfillment server notifies the SAHOA that the data is not available in step 630.

The SAHOA notifies the CAHOA that the data is not available in step 631. This change is indicated by the CAHOA in some way, possibly an icon on the client's display device flashing.

The AHO goes to the Orphan List (step 632), the two Agent programs stop (step 633 for the SAHOA and step 634 for the CAHOA) and the process ends.

FIG. 7 shows the components involved in the interaction between clients and web server when the web server is not available and a standby server is used to keep track of client requests. As in FIG. 2, block 10 is the client, block 20 is the web server, block 30 is the Server AHO Agent, block 40 is the Server AHO Fulfillment server, block 50 is the Client AHO Fulfillment server, block 60 is the Client AHO Agent, and block 70 indicates other devices which may be used to notify clients of changes in the status of their request. The only difference is the addition of block 80 which is a standby server.

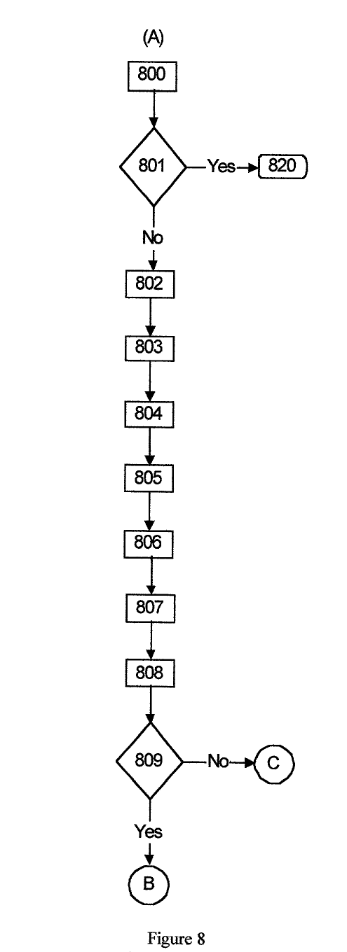

FIG. 8 is a flow chart describing the steps involved in using a standby server. The process starts when the client requests data from a server in step 800. Step 801 indicates that there are two possibilities as to the availability of the server.

If the server is available, the process is the same as that in the flow chart in FIG. 3. Step 820 indicates that the server handles the request, which is the same as going to step 301 in the flow chart of FIG. 3.

If the server is down for maintenance or any other reason, the client's request is passed to the standby server as in step 802.

In step 803, the standby server creates a Server AHO Agent. This SAHOA is added to the SAHOA list. In step 804 the SAHOA registers with the Server AHO Fulfillment server.

In step 805, the SAHOA registers with the Client AHO Fulfillment server.

In step 806, the Standby server informs the client that the data requested is not immediately available, but that an AHO agent has been initiated and the client will be informed when the data does become available.

The client initiates the Client AHO Agent program in step 807 and adds it to the CAHOA list.

The CAHOA registers with the Client AHO Fulfillment server in step 808.

At this point, the work of the standby server is done and from step 809 on, the asynchronous interaction between client and web browser continues as normal as soon as the web browser is online again. Processes B and C indicated in FIG. 8 are the same processes B and C as shown in FIG. 3B and FIG. 3C.

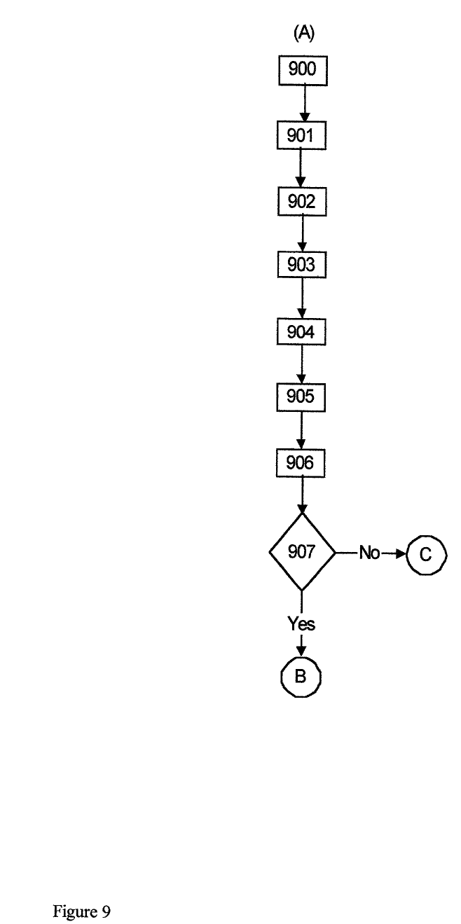

FIG. 9 is a flow chart describing the steps involved in using an asynchronous server. The components involved in the process are the same as in FIG. 2 except that the web server only works in asynchronous mode. This means that the server always responds to a client request by creating a Server AHO Agent. The steps are the same as in the normal asynchronous process, except in that the asynchronous server does not have an option to fulfill the client's request in real time. The process starts when the client requests data from the server, step 900. Since there is no synchronous interaction in this case, the asynchronous interaction starts.

Step 901 describes the web server initiating the Server AHO Agent, or SAHOA, program. This SAHOA is added to the SAHOA list. In step 902, the SAHOA registers with the Server AHO Fulfillment server, and in step 903, the SAHOA registers with the Client AHO Fulfillment server.

In step 904, the web server informs the client that the data requested is not immediately available, but that an AHO agent has been initiated and the client will be informed when the data does become available.

The client initiates the Client AHO Agent, or CAHOA, program in step 905. This CAHOA is added to the CAHOA list.

In step 906, the CAHOA registers with the Client AHO Fulfillment server. The presence of this active Client AHO Agent is shown by updating the appropriate icons on the client's display device.

Step 907 indicates there are two outcomes to the search for the data requested. Either the data is found, process B, or it is not found, process C. Processes B and C indicated in FIG. 9 are the same processes B and C shown in FIG. 3B and FIG. 3C.

1. A system of asynchronous communication between clients and web servers, whereby the client requests data from the web server, and the data is not immediately available; said request to data is represented by an Asynchronous Hyperlink Object (AHO) and the web server acknowledges the request to the client and fulfills the request at a later time when said data is available.

2. A system as defined in claim 1 whereby normal, or synchronous, hyperlinks are converted to AHOs and AHOs are converted to normal hyperlinks.

3. A system as in claim 1, comprising in addition of a software or hardware component in the client and/or a separate system, said component is herein defined as Client AHO Agent (CAHOA), and it's function is to interact with the AHO on behalf of the client.

4. A system as in claim 3, wherein the CAHOA is pre-built or pre-installed in the client and/or other system or created/deployed in the moment an AHO is created or deployed on behalf of the client.

5. A system as in claim 1, comprising in addition of a software or hardware component in the Server system, said component is herein defined as a Server AHO Agent (SAHOA), and it's function is to interact with the AHO on the server side.

6. A system as in claim 5, wherein the SAHOA is pre-built or pre-installed in the server system or created/deployed in the moment the AHO is created.

7. A system as in claim 1 in which the AHOs in progress are represented in the client system in a graphical user interface, wherein said graphical user interface is standalone or part of an existing graphical user interface.

8. A system as in claim 7, in which an icon indicates when a change occurs in the status of any one of the AHOs.

9. A system as in claim 7 wherein each AHO is further represented by an individual icon, herein defined as AHO Icon.

10. A system as in claim 9, in which the AHO Icon can change in form or color and said change represents or indicates that a change has occurred in the AHO's process.

11. A system as in claim 7, in which the graphical user interface consists of a list and said list lists every AHO in progress.

12. A system as in claim 7, in which every AHO whose process ends successfully goes to the history list.

13. A system as in claim 7, in which an AHO that is terminated by the client or server prior to its completion becomes an Orphan AHO and goes to the orphan list.

14. A system as defined in claim 1, whereby the client request cannot be exactly fulfilled by the web server and instead, the fulfillment consist of at least one alternative.

15. A system as defined in claim 14, whereby the nature of the alternative is governed by “affinity rules” or a system that determines or selects items that are close or related to the original request

16. A system as defined in claim 14, whereby the alternative consists of at least one new AHO request.

17. A system as in claim 1, whereby the web server cannot fulfill the client's request exactly because of an error in the request, said web server corrects said client's request.

18. A system as in claim 17, whereby the fulfillment consists of modifying the client request and automatically fulfilling said modified request.

19. A system as defined in claim 17, whereby the modified request is presented to the client before proceeding to fulfill the request.

20. A system as in claim 17, whereby the client request cannot be exactly fulfilled by the server and instead, the web server notifies the client and requests that the client modify the request.

21. A system as in claim 1, whereby the client request results in a specific type of AHO, wherein the server is able to predict the completion time and the client is notified of this time, and said type of AHO is herein defined as a Predictable AHO.

22. A system as in claim 1, whereby the client request results in a specific type of AHO, wherein the server does not or is not capable of predicting the completion time for the request and the client is notified of the undetermined completion time, and said type of AHO is herein defined as an Unpredictable AHO.

23. A system as in claim 1, whereby the client request results in a specific type of AHO, wherein the server schedules the completion time for the request and the client is notified of said scheduled completion time, and said type of AHO is herein defined as Time-based AHO.

24. A system as in claim 23, in which said specific date and time is a periodic event.

25. A system as defined in claim 23, whereby the resulting AHO fulfills the request in a periodic manner until a final event is reached.

26. A system as in claim 1, whereby the client request results in a specific type of AHO, wherein the web server informs the client that the web server will fulfill the request once the web server receives a predetermined number of similar requests, and said type of AHO is herein defined as Count-based AHO.

27. A system as in claim 1, whereby the client request results in a specific type of AHO, wherein the web server informs the client that the web server will fulfill the request once a predetermined condition is met, and said type of AHO is herein defined as Condition-based AHO.

28. A system as in claim 1, whereby the client request results in an AHO and the fulfillment of the AHO is based on a server-side priority system or rating.

29. A system as in claim 1, further comprising of at least one standby server, which is functional whenever the web server is unavailable for any reason, said standby server acknowledges the receipt of requests from all clients, and generates AHO agents in response to the requests, so that no client request is ignored.

30. A system as in claim 1 whereby the web server behaves in the asynchronous model only and said web servers are herein defined as Asynchronous Web Servers.

31. A system as defined in claim 1, wherein an AHO can terminate without completely fulfilling the client's request.

32. A system as defined in claim 1, wherein the termination is determined by a set of predetermined rules.

33. A system as defined in claim 1, wherein the client initiates the termination of an AHO without the client request being fulfilled.

34. A system as defined in claim 1, wherein an AHO, upon termination, generates at least one additional AHO, and said type of AHO is herein defined as Derivative AHO.

35. A system as defined in claim 1, wherein, upon the termination of an AHO, the client determines the generation of derivatives AHOs.

36. A system as defined in claim 35, wherein the derivative AHOs are automatically deployed.

37. A system as defined in claim 35, wherein derivative AHOs can generate at least one additional derivative AHO.

38. A system as defined in claim 35, wherein the generation and deployment rules of derivative AHOs are determined by other AHOs or derivative AHOs.
